(19) United States
(12) Patent Application Publication
(10) Pub. No.: US 2019/0339376 A1
(43) Pub. Date: Nov. 7, 2019

(54) DIFFERENTIAL PHASE-BASED DETECTOR

(71) Applicant: GM GLOBAL TECHNOLOGY OPERATIONS LLC, Detroit, MI (US)

(72) Inventors: Moshe Levy-Israel, Ashdod (IL); Igal Bilik, Rehovot (IL)

(21) Appl. No.: 15/971,802

(22) Filed: May 4, 2018

(51) Int. Cl. G01S 13/58; H04B 7/0413; G01S 13/93

(52) U.S. Cl. CPC G01S 13/582; G01S 2013/0254; G01S 13/931; H04B 7/0413

(57) ABSTRACT

A vehicle, vehicular system and a method of detecting an object. The vehicular system includes a multi-input multi-output (MIMO) radar array and a processor. The MIMO radar array is configured to obtain a radar signal from the object. The processor is configured to determine a differential phase of the radar signal for the MIMO array, generate a probability map from a sign of the differential phase, and confirm the detection of the object

### INTRODUCTION

The subject disclosure relates to reducing the occurrence of false alarms in automotive radar systems and, in particular, to a system and method of signal detection based on a differential phase of a radar array of a vehicle.

Many vehicles include radar systems for determining parameters of an object in an environment of the vehicle, such as a range and velocity of the object with respect to the vehicle. Determining these parameters allows the driver or an autonomous driving system of the vehicle to take an action in order to avoid contact with the object. A multi-input-multi-output (MIMO) radar system on a vehicle transmits a sequence of signals into the environment and receives reflections of the transmitted signals from the object. The reflected signals generate energy peaks in a frequency space. A detection of the object is determined for a peak having an intensity that exceeds a selected threshold. Due to noise and other radar system characteristics, it is possible to have false alarms or, in other words, peaks that exceed the selected threshold but are not related to the object. Accordingly, it is desirable to be able to differentiate between false alarm peaks and detection peaks that are related to the object.

### SUMMARY

In one exemplary embodiment, a method of detecting an object is disclosed. The method includes obtaining a radar signal from the object at a multi-input multi-output (MIMO) radar array, determining a differential phase of the radar signal for the MIMO array, generating a probability map from a sign of the differential phase, and confirming the detection of the object from the probability map.

In addition to one or more of the features described herein, the method includes determining a positive phase detection for a value of the probability map that exceeds a probability threshold. The method further includes generating a range-Doppler energy map and determining a positive energy detection for a peak of the range-Doppler map that exceeds an energy threshold. In one embodiment, the detection of the object at a range and velocity is confirmed from a weighted sum of the positive energy detection and the positive phase detection at the range and velocity. In another embodiment, the probability map is compared to the probability threshold using the value associated with the positive energy detection. The probability map includes an object detection probability that is a summation of signs of differential phase of the signal from transmitters of the MIMO array. In various embodiment, the vehicle is navigated with respect to the object based on the detection.

In another exemplary embodiment, a vehicular system for detecting an object is disclosed. The vehicular system includes a multi-input multi-output (MIMO) radar array and a processor. The MIMO radar array is configured to obtain a radar signal from the object. The processor is configured to determine a differential phase of the radar signal for the MIMO array, generate a probability map from a sign of the differential phase, and confirm the detection of the object from the probability map.

In addition to one or more of the features described herein, the processor is further configured to determine a positive phase detection for a value of the probability map that exceeds a probability threshold. The processor is further configured to generate a range-Doppler energy map and determine a positive energy detection for a peak of the range-Doppler map that exceeds an energy threshold. In one embodiment, the processor is further configured to confirm the detection of the object at a range and velocity from a weighted sum of the positive energy detection and the positive phase detection at the range and velocity. In another embodiment, the processor is further configured to compare the value of the probability map to the probability threshold using the value associated with the positive energy detection. The probability map includes an object detection probability that is a summation of signs of differential phase of the signal between transmitters of the MIMO array. The processor is further configured to navigate the vehicle with respect to the object based on the detection of the object.

In yet another exemplary embodiment, a vehicle is disclosed. The vehicle includes a multi-input multi-output (MIMO) radar array and a processor. The MIMO radar array is configured to obtain a radar signal from an object. The processor configured to determine a differential phase of the radar signal for the MIMO array, generate a probability map from a sign of the differential phase, and confirm the detection of the object from the probability map.

In addition to one or more of the features described herein, the processor is further configured to determine a positive phase detection for a value of the probability map that exceeds a probability threshold. The processor is further configured to generate a range-Doppler energy map and determine a positive energy detection for a peak of the range-Doppler map that exceeds an energy threshold. In one embodiment, the processor is further configured to determine the detection of the object at a range and velocity from a weighted sum of the positive energy detection and the positive phase detection at the range and velocity. In another embodiment, the processor is further configured to compare the value of the probability map to the probability threshold using the value associated with the positive energy detection. The probability map includes an object detection probability that is a summation of signs of differential phase of the signal between transmitters of the MIMO array.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle with an associated trajectory planning system in accordance with various embodiments;

FIG. 2 shows an illustrative multi-input and multi-output (MIMO) array that can be used with the vehicle of FIG. 1;

FIG. 3 shows a time diagram illustrating transmission signals from the set of transmitters of the MIMO array;

FIG. 4 shows a transmitter array having N transmitters and a plurality of associated transmitter signals;

FIG. 5 shows a configuration of a time-division multiple access multi-input multi-output array suitable for determining false alarms based on a differential phase between transmitters and receivers;

FIG. 6 shows a schematic diagram illustrating a first method of detecting an object using differential phase;

FIG. 7 shows a schematic diagram illustrating a second method of detecting an object using differential phase; and

FIG. 8 shows an illustrative Range Doppler Map and a vehicle-centered grid.

### DETAILED DESCRIPTION

The following description is merely exemplary in nature and is not intended to limit the present disclosure, its application or uses. It should be understood that throughout the drawings, corresponding reference numerals indicate like or corresponding parts and features.

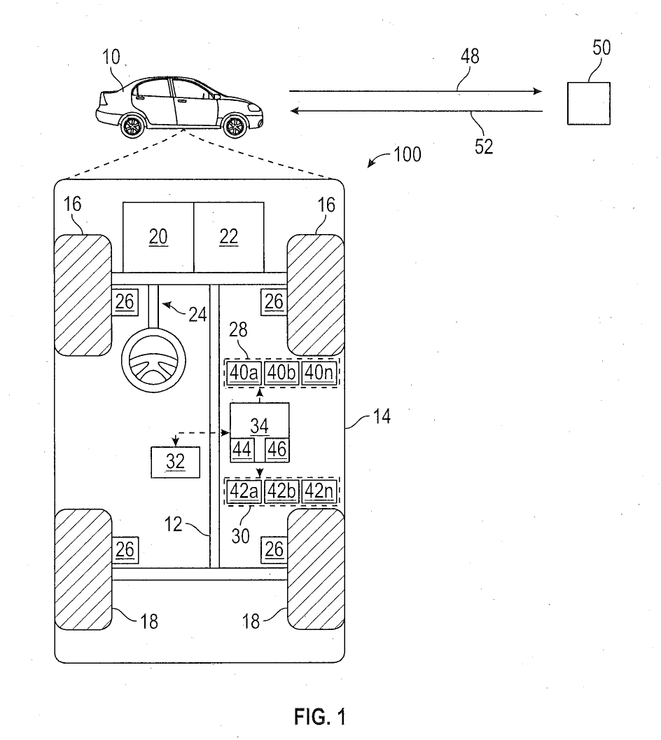

In accordance with an exemplary embodiment, FIG. 1 shows a vehicle 10 with an associated trajectory planning system depicted at 100 in accordance with various embodiments. In general, the trajectory planning system 100 determines a trajectory plan for automated driving of the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

In various embodiments, the vehicle 10 is an autonomous vehicle and the trajectory planning system 100 is incorporated therein. The vehicle 10 can, for example, be automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20, a transmission system 22, a steering system 24, a brake system 26, a sensor system 28, an actuator system 30, at least one data storage device 32, and at least one controller 34. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. In various embodiments, the vehicle 10 includes a multi-input-multi-output (MIMO) radar system including an array of radar transducers, the radar transducers being located at various locations along the vehicle 10. In operation, a radar transducer sends out electromagnetic pulses 48 that are reflected back at the vehicle 10 by the object 50. The reflected pulses 52 are received at the transducers in order to determine parameters such as range and Doppler (velocity) of the object 50.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as ventilation, music, lighting, etc. (not numbered).

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The trajectory planning system 100 navigates the autonomous vehicle 10 based on a determination of objects and/their locations within the environment of the vehicle. In various embodiments the controller 34 performs calculations to determine the presence and/or location of an object in the vehicle's environment from the reflections 52, which includes a consideration of a phase of the reflections as they are received at the MIMO array. Upon determining various parameters of the object, such as range, azimuth, elevation, velocity, etc., from the plurality of detections, the controller 34 can operate the one or more actuator devices 42a-n, the propulsion system 20, transmission system 22, steering system 24 and/or brake 26 in order to navigate the vehicle 10 with respect to the object 50. In various embodiments, the controller 34 navigates the vehicle 10 so as to avoid contact with the object 50.

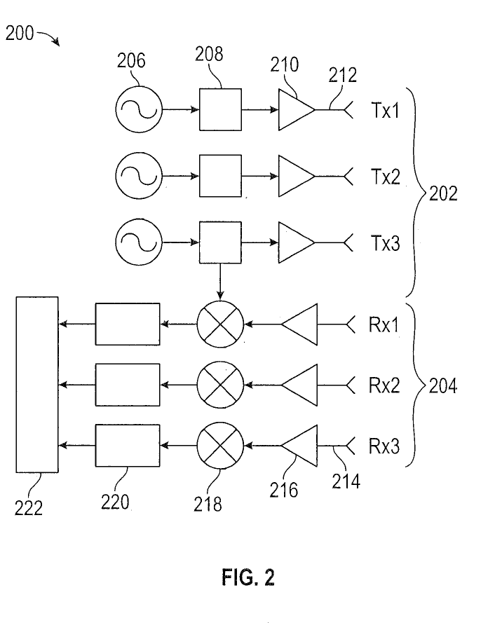

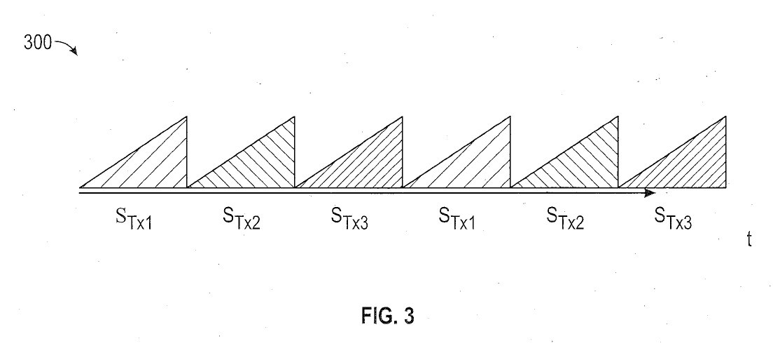

FIG. 2 shows an illustrative multi-input and multi-output (MIMO) array 200 that can be used with the vehicle 10 of FIG. 1. The MIIMO array 200 includes a set of transmitters 202 and a set of receivers 204. In various embodiments, the MIMO array 200 can include a set of transducers, with each transducer serving as both a transmitter and a receiver. Each transmitter includes a waveform generator 206, a trigger circuit 208, an amplifier 210 and transmitter antenna 212. The waveform generator 206 provides an RF pulse for transmission. In various embodiments, the RF pulse is a linear frequency modulated (LFM) signal, also known as a chirp signal, in which the frequency of the signal increases from a first frequency to a second frequency over the duration of the signal in a linear fashion. The trigger circuit provides the chirp signal to the transmitter antenna 212 according to a time schedule. In various embodiments, the trigger circuits of the transmitters are synchronized for time-division multiplexing of its transmitted signals, as shown in FIG. 3.

FIG. 3 shows a time diagram 300 illustrating transmission signals from the set of transmitters of the MIMO array. A set of k transmitters Tₓ₁, . . . , Tₛₖ transmits k signals S_{Tx1}, . . . , S_{Txk} in sequence. Time diagram 300 illustrates this sequence for k=3 transmitters. The time diagram shows a first signal (S_{Tx1}) transmitted from a first transmitter (Tₓ₁), followed in sequence by a second signal (S_{Tx2}) transmitted from a second transmitter (Tₓ₂) which is followed in sequence by a third signal (S_{Tx3}) transmitted from a third transmitter (Tₓ₃). After the third signal has been transmitted, the cycle repeats. The first, second and third signals are chirp signals. The rising edge of the signals indicates the increase in frequency of the chirp signals over time.

Returning to FIG. 2, a signal from the trigger circuit 208 is amplified at the amplifier 210 and provided to transmitter antenna 212 which propagates the signal into the environment surrounding the vehicle (10, FIG. 1). Each receiver of the set of receivers 204 includes a receiver antenna 214, an amplifier 216, a multiplexer circuit 218 and an analog-digital converter (ADC) 220. The receiver antenna 214 receives a reflection of the RF signal from various objects in the environment surrounding the vehicle (10, FIG. 1) and provides the signal to the amplifier 216. The amplifier 216 amplifies the signal and can also remove low noise signals from the signal in various embodiments. The amplified signal is provided to the multiplexer circuit 218. The multiplexer circuit 218 is synchronized with the trigger circuit in order to establish a phase relation between the set of transmitters 202 and the set of receivers 204. The multiplexed signal is provided to the ADC 220 which converts the multiplexed signal to a digital signal which can be processed using various methods at the digital processing unit 222 or processor (44, FIG. 1)

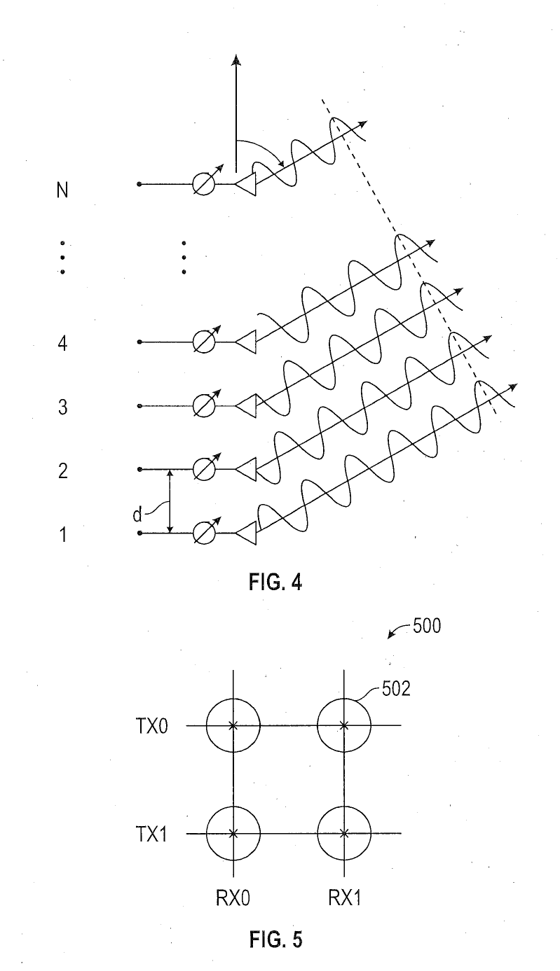

FIG. 4 shows a transmitter array having N transmitters and a plurality of associated transmitter signals. A phase difference Asp between transmitter signals from the transmitter array is indicated by:

Δφ=Δφ_{R}+Δφ_{D} Eq. (1)

where Δφ_{R} is a phase difference that is related to a separation or distance between transmitters, and Δφ_{D} is a Doppler phase difference that is due to the phase differences of the frequencies of the chirp signals.

FIG. 5 shows a configuration of a time-division multiple access (TDMA) multi-input multi-output (MIMO) array 500 suitable for determining false alarms based on a differential phase between transmitters and receivers. The array 500 includes transmitters, such as transmitter TX0 and transmitter TX1, which are aligned along an axis, such as y-axis. Receivers, such as receivers RX0 and RX1, are aligned along an axis that is perpendicular to the axis of the transmitters, such as along x-axis.

Although shown with only two transmitters and two receivers for illustrative purposes, the TDMA MIMO array (500) in general includes K transmitters and L receivers. This arrangement produces a location 502 at which a virtual signal is received. This virtual channel can be indicated by VCE(k,l) and a linear frequency modulated (LFM) signal received at virtual receiver VCE(k, l) can be expressed by the following formula:

x₀(t,n,k,l)=Ae^{jw}^{_{c}}^{t}e^{jw}^{_{d}}^{nT}^{_{c}}e^{j(ƒ(k)+g(l))} Eq. (2)

where x₀(t, n, k, l) is the signal corresponding to the k^{th} transmitter and the l^{th} receiver, t is continuous time, n is a chirp index, ω_{c} is carrier angular frequency, ω_{D} is Doppler angular frequency and T_{c} is a chirp duration. Function ƒ(k) is a wave function of the k^{th} transmitter location and g(l) is a wave function of the l^{th} receiver.

A chirp signal received at the same virtual receiver from an adjacent transmitter k′ (where k′=mod (k+1, K)) is given by Eq. (3)

x₁(t,n+1,k′,l)=Ae^{jw}^{_{c}}^{t}e^{jw}^{_{d}}^{(n+1)T}^{_{c}}e^{j(ƒ(k′)+g(l))} Eq. (3)

By defining y(k, l) as the l-element-wise conjugate multiplication of x₀ with x₁, then:

y(k,l)=x₀*conj{x₁}=ABe^{jw}^{_{d}}e^{j(ƒ(k)-ƒ(k′))} Eq. (4)

By applying a Doppler correction to Eq. (4), then:

y(k,k′)=Ce^{j*ƒ(k,k′)} Eq. (5)

The constant differential phase ƒ (k, k′) is a function of the coupling distance between transmitters k and k′. If the distance between antennas and k′ d, then Eq. (5) can be rewritten as:

y(θ)=Ce^{j2πd sin(θ)} Eq. (6)

Eq. (6) illustrates that y(θ) is invariant with respect to the l index and that the phase across the receiver elements is constant. Therefore, one can measure the sign coherency across the receiver elements by summing the L signs. When the detection is a real detection (i.e., not a false alarm), all the signs will be summed coherently and the absolute value will be L.

A probability P of a detection (“an object detection probability”) can be defined by:

$$P = \frac{{Σ}_{k} \vert {Σ}_{l} sign ( imag ( {y}_{k , l} ( θ ) ) ) \vert}{KL} \qquad Eq . ( 7 )$$

Since the probability P is based on the summation of the signs of the signals, for a real signal, the probability will be near one. In order to reduce the effects of noise, it is possible to sum the signal so that the variation caused by noise is reflected as a change in sign, thereby causing noise signals to cancel each other out. In order to produce sign variation due to noise variation, the mean angle of the signals is aligned along a constant phase angle (π/2). Thus:

$$\begin{matrix}{y}_{norm} ( k , l ) = y ( k , l ) {e}^{j * ( \frac{π}{2} - angle ( mean ( y ) )} \\ and & Eq . ( 8 ) \\ P = \frac{{Σ}_{k} \vert {Σ}_{l} sign ( imag ( {y}_{norm , k , l} ( θ ) ) ) \vert}{KL} & Eq . ( 9 )\end{matrix}$$

The probability P is a summation of the signs of the imaginary part of the conjugation multiplication across the MIMO array and is normalized for the number of receivers and transmitters. Since noise has an incoherent phase relation, the value of P for a noise signal is approximately zero. On the other hand, a non-noise signal has a relative coherent phase relation, causing the value of P for a non-noise signal to approach the product KL. The summations on the right-hand side provide a number between zero and KL. By normalizing (i.e., by dividing by KL), the probability P has a value between zero and 1. A real target signal in general has a much higher value than a false alarm signal. Therefore, the value of the probability P can be used to reduce the number of false alarms or false detections at the MIMO array, as discussed herein.

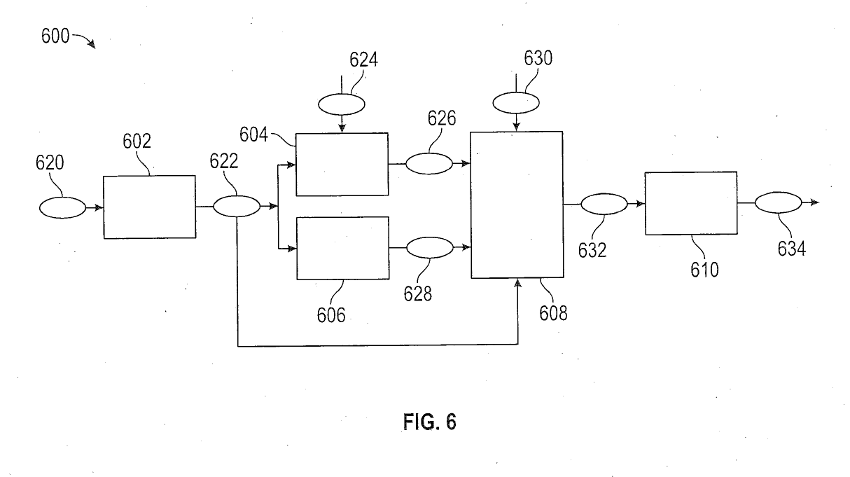

FIG. 6 shows a schematic diagram illustrating a first method of detecting an object using values of the probability P. The diagram 600 includes a two-dimensional Fast Fourier Transform (2D FFT) module 602, a beamforming energy map generator 604, a differential phase map generator 606, a detector 608 and a direction of arrival module 610.

The (2D FFT) module 602 receives a digitized two-dimensional radar signal 620 and generates a Range-Doppler map 622 from the two-dimensional radar signal 620. The Range-Doppler map 622 is provided to both the beamforming energy map generator 604 and the differential phase map generator 606. The beamforming energy map generator 604 receives a steering matrix 624 and produces an Energy Map 626 for the Range-Doppler signal by associating an intensity of a signal with a range and velocity. The differential phase map generator 606 produces a differential phase probability map 628 (also referred to herein as a “probability map”) using the object detection probability calculations discussed with respect to Eqs. (2)-(9).

The Range-Doppler Energy Map 626 and the probability map 628 are provided to detector 608 which determines one or more detections 632 therefrom. The detector 608 also receives a probability threshold and energy threshold 630. The detector 608 compares values in the Energy Map 626 to the energy threshold in order to identify a positive energy detection. Similarly, the detector 608 compares probability values in the probability map 628 to the probability threshold to determine positive phase detections. The detector 608 provides uses a weighted sum of the positive energy detection and the positive phase detection in order to confirm the detections 632. The confirmed detections 632 are provided to the direction of arrival module 610 which determines parameters 634 such as direction of arrival, thereby obtain range, Doppler, azimuth and elevation for the confirmed detection 632. The parameters 634 can be plotted on a grid in order to show their relation to the vehicle. The range, Doppler, azimuth and elevation of the detection can be provided for further processing in order to identify an object in order to navigating the vehicle with respect to the object.

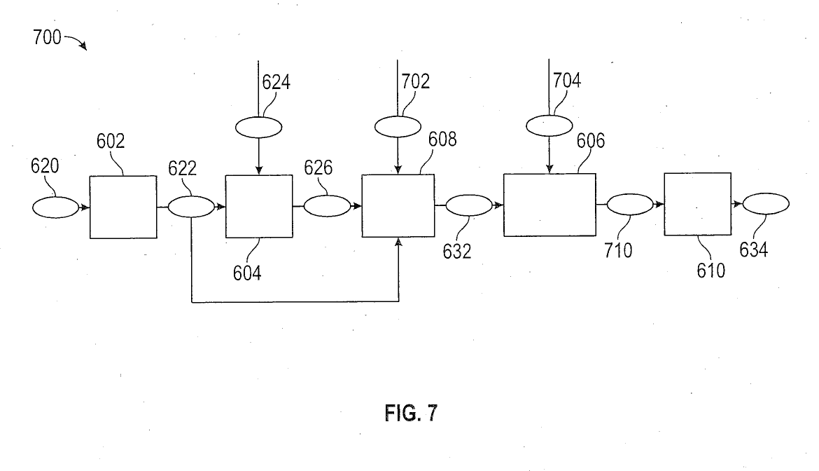

FIG. 7 shows a schematic diagram illustrating a second method of detecting an object using the probability P. The schematic diagram 700 includes the two-dimensional Fast Fourier Transform (2D FFT) module 602, the beamforming energy map generator 604, the differential phase map generator 606, the detector 608 and the direction of arrival module 610. The arrangement of the beamforming energy map generator 604, the differential phase map generator 606 and the detector 608 is different from in FIG. 6.

The (2D FFT) module 602 receives the digitized two-dimensional radar signal 620 and generates a Range-Doppler map 622 from the two-dimensional radar signal 620. The Range-Doppler map 622 is provided to both the beamforming energy map generator 604 and the detector 608. The beamforming energy map generator 604 receives the Range-Doppler map 622 and a steering matrix 624 and produces an Energy Map 626 for the Range-Doppler signal by associating an intensity of a signal with a range and velocity. The Energy Map 626 is provided to the detector 608 which also receives an energy threshold map 702. The detector 608 compares intensity values in the energy map 626 to the corresponding threshold values in the threshold map 702 in order to determine one or more positive energy detections 632.

The positive energy detections 632 are provided to the differential phase map generator 606, which also receives a probability map 704. For those values provided to the differential phase map generator 606, i.e., those values for which there is a positive energy detection, the differential phase map generator 606 determines an object detection probability and compares the object detection probability to a probability threshold of the probability map 704, in order to determine one or more positive phase detections 710. Thus, when there is a positive energy detection and a positive phase detection, the differential phase map generator confirms a detection 710. The confirmed detections 710 are provided to the direction of arrival module 610. The direction of arrival module 610 determines parameters 634 such as a direction of arrival, thereby obtain range, Doppler, azimuth and elevation for the confirmed detections. The parameters 634 can be plotted on a grid in order to show their relation to the vehicle.

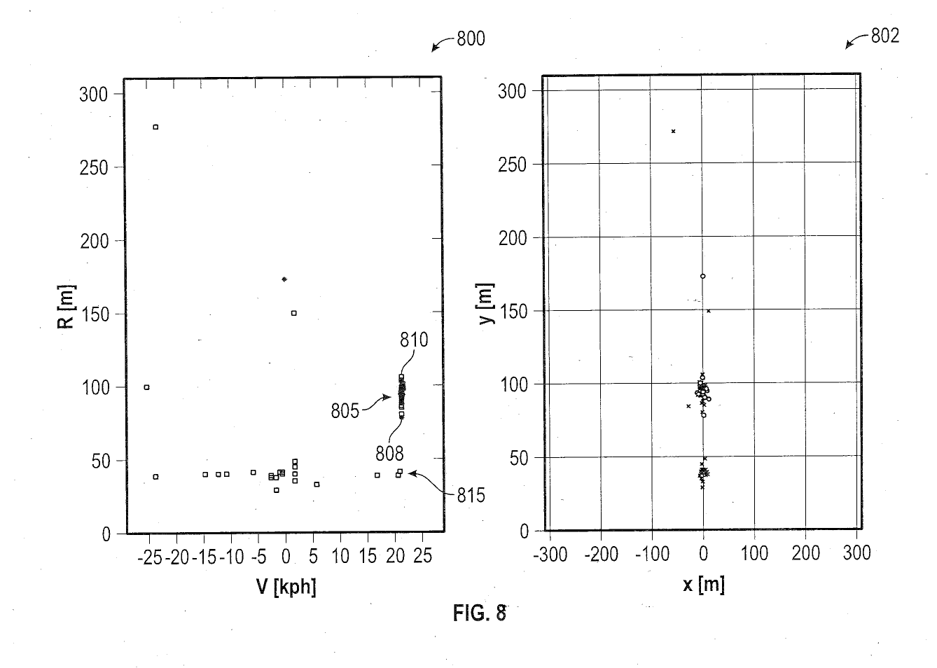

FIG. 8 shows an illustrative Range Doppler Map 800 and a vehicle-centered grid 802. The Range-Doppler map 800 shows a plurality of signals obtained over a range of about 200 meters within a velocity of form about −30 kilometers per hour (kph) to about +30 kph. A cluster of confirmed detections 805 is shown at about 100 meters moving at about 20 kph with respect to the MIMO array. Also, a number of false alarms 815 detections are shown at about 40 meters. These false alarms are filtered out by use of the phase detector disclosed herein. The confirmed energy detections at (100 m, 20 kph) are signified by an indicator 808 which can be color-coded. Confirmed phase detections are marked using square markers 810. A detection can be confirmed at locations which have both a positive energy detection and a positive phase detection. The confirmed detections are them mapped on the grid 802.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of detecting an object, comprising:
obtaining a radar signal from the object at a multi-input multi-output (MIMO) radar array;
determining a differential phase of the radar signal for the MIMO array;
generating a probability map from a sign of the differential phase; and
confirming the detection of the object from the probability map.

2. The method of claim 1, further comprising determining a positive phase detection for a value of the probability map that exceeds a probability threshold.

3. The method of claim 2, further comprising generating a range-Doppler energy map and determining a positive energy detection for a peak of the range-Doppler map that exceeds an energy threshold.

4. The method of claim 3, further comprising confirming the detection of the object at a range and velocity from a weighted sum of the positive energy detection and the positive phase detection at the range and velocity.

5. The method of claim 3, further comprising comparing the probability map to the probability threshold using the value associated with the positive energy detection.

6. The method of claim 1, wherein the probability map includes an object detection probability that is a summation of signs of differential phase of the signal from transmitters of the MIMO array.

7. The method of claim 1, further comprising navigating the vehicle with respect to the object based on the detection.

8. A vehicular system for detecting an object, comprising:
a multi-input multi-output (MIMO) radar array configured to obtain a radar signal from the object;
a processor configured to:
determine a differential phase of the radar signal for the MIMO array,
generate a probability map from a sign of the differential phase, and
confirm the detection of the object from the probability map.

9. The system of claim 8, wherein the processor is further configured to determine a positive phase detection for a value of the probability map that exceeds a probability threshold.

10. The system of claim 9, wherein the processor is further configured to generate a range-Doppler energy map and determine a positive energy detection for a peak of the range-Doppler map that exceeds an energy threshold.

11. The system of claim 10, wherein the processor is further configured to confirm the detection of the object at a range and velocity from a weighted sum of the positive energy detection and the positive phase detection at the range and velocity.

12. The system of claim 10, wherein the processor is further configured to compare the value of the probability map to the probability threshold using the value associated with the positive energy detection.

13. The system of claim 8, wherein the probability map includes an object detection probability that is a summation of signs of differential phase of the signal between transmitters of the MIMO array.

14. The system of claim 8, wherein the processor is further configured to navigate the vehicle with respect to the object based on the detection of the object.

15. A vehicle, comprising:
a multi-input multi-output (MIMO) radar array configured to obtain a radar signal from an object;
a processor configured to:
determine a differential phase of the radar signal for the MIMO array,
generate a probability map from a sign of the differential phase, and
confirm the detection of the object from the probability map.

16. The vehicle of claim 15, wherein the processor is further configured to determine a positive phase detection for a value of the probability map that exceeds a probability threshold.

17. The vehicle of claim 16, wherein the processor is further configured to generate a range-Doppler energy map and determine a positive energy detection for a peak of the range-Doppler map that exceeds an energy threshold.

18. The vehicle of claim 17, wherein the processor is further configured to determine the detection of the object at a range and velocity from a weighted sum of the positive energy detection and the positive phase detection at the range and velocity.

19. The vehicle of claim 17, wherein the processor is further configured to compare the value of the probability map to the probability threshold using the value associated with the positive energy detection.

20. The vehicle of claim 15, wherein the probability map includes an object detection probability that is a summation of signs of differential phase of the signal between transmitters of the MIMO array.
